(19) United States
(12) Patent Application Publication
(10) Pub. No.: US 2011/0102556 A1
(43) Pub. Date: May 5, 2011

(54) METHOD FOR DISPLAYING 3D IMAGE BY USING THE BINOCULAR DISPARITY IN MOBILE TERMINAL AND MOBILE TERMINAL USING THE SAME

(76) Inventors: Sungdo KIM, Seoul (KR); Jonghwan Kim, Seoul (KR)

(21) Appl. No.: 12/899,400

(22) Filed: Oct. 6, 2010

(30) Foreign Application Priority Data
Nov. 3, 2009 (KR) 10-2009-0105261
Nov. 3, 2009 (KR) 10-2009-0105262

(51) Int. Cl. H04N 13/02

(52) U.S. Cl. 348/51; 348/E13.075

(57) ABSTRACT

A method of controlling a mobile terminal, and which includes receiving a selection signal from an input unit setting a 3D attribute to at least one item among a plurality of items to be displayed on a display of the mobile terminal; and turning on a switching panel unit positioned in front of the display, via a controller controlling the switching panel unit, when the at least one item is displayed on the display of the mobile terminal. Further, the switching panel unit displays left and right eye images of the at least one item such that the at least one item is viewed as a 3D image based on binocular disparity.

### CROSS-REFERENCE TO RELATED APPLICATIONS

Pursuant to 35 U.S.C. §119 (a), this application claims the benefit of earlier filing date and right of priority to Korean Patent Application Nos. 10-2009-0105261 filed on Nov. 3, 2009, and 10-2009-0105262 filed on Nov. 3, 2009, the contents of which are hereby incorporated by reference in their entirety.

### BACKGROUND OF THE INVENTION

1. Field of the Invention

The present invention relates to a mobile terminal and corresponding method for displaying a 3D image using binocular disparity.

2. Discussion of the Related Art

Generally, terminals can be classified into mobile/portable terminals and stationary terminals. The mobile terminals can be further classified into handheld terminals and vehicle mount terminals. Mobile terminals also allow the user to perform a variety of functions such as photographing photos or moving pictures, playing music or moving picture files, playing games, watching broadcasts and the like, for example. Thus, the mobile terminal functions as a multimedia player.

However, because the mobile terminal is small in size, it is sometimes difficult to operate or see the variety of different functions provided on the terminal.

### SUMMARY OF THE INVENTION

Accordingly, one object of the present invention is to address the above-noted and other problems of the related art.

Another object of the present invention is to provide a mobile terminal and corresponding method for displaying a 3D image using binocular disparity.

Yet another object of the present invention is to provide a user interface including a GUI (graphic user interface) that is more convenient and more visible to a user by generating a 3D image using binocular disparity, allows a user to set up an attribute of 3D image, displays a 3D image imaginary space and changes a display of the imaginary space displayed through an inclination sensor.

To achieve these and other advantages and in accordance with the purpose of the present invention, as embodied and broadly described herein, the present invention provides in one aspect a method of controlling a mobile terminal, and which includes receiving a selection signal from an input unit setting a 3D attribute to at least one item among a plurality of items to be displayed on a display of the mobile terminal; and turning on a switching panel unit positioned in front of the display, via a controller controlling the switching panel unit, when the at least one item is displayed on the display of the mobile terminal. Further, the switching panel unit displays left and right eye images of the at least one item such that the at least one item is viewed as a 3D image based on binocular disparity. The present invention also provides a corresponding mobile terminal.

In another aspect, the present invention provides a method of controlling a mobile terminal, and which includes displaying, on a display of the mobile terminal, only a first portion of a 3D imaginary spatial image pre-stored in a memory of the mobile terminal by turning on a switching panel unit of the mobile terminal; receiving an inclination signal indicating an inclination of the mobile terminal; and displaying a second portion of the 3D imaginary spatial image on the display that is different than the first portion in response to the inclination detection signal. The present invention also provides a corresponding mobile terminal.

Further scope of applicability of the present invention will become apparent from the detailed description given hereinafter. However, it should be understood that the detailed description and specific examples, while indicating preferred embodiments of the invention, are given by illustration only, since various changes and modifications within the spirit and scope of the invention will become apparent to those skilled in the art from this detailed description.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is a block diagram of a mobile terminal according to an embodiment of the present invention;

FIG. 2A is a front perspective view of a mobile terminal according to an embodiment of the present invention;

FIG. 2B is a rear perspective view of a mobile terminal according to an embodiment of the present invention;

FIG. 3 is a schematic view explaining a principle of displaying a 3D image using binocular disparity in a mobile terminal according to an embodiment of the present invention;

FIG. 4 is a flowchart illustrating a method for displaying a 3D image using binocular disparity in a mobile terminal according to a first embodiment of the present invention;

FIG. 5 is a flowchart illustrating a method for displaying a 3D image using binocular disparity in a mobile terminal according to a second embodiment of the present invention;

FIG. 6 is a flowchart illustrating a method for displaying a 3D image using binocular disparity in a mobile terminal according to a third embodiment of the present invention;

FIG. 7 includes overviews of display screens illustrating a 3D image in a mobile terminal according to an embodiment of the present invention;

FIGS. 8A to 8E are overviews of display screens illustrating a 3D image in a mobile terminal according to another embodiment of the present invention;

FIGS. 9A to 9D are overviews of display screens illustrating a 3D image in a mobile terminal according to still another embodiment of the present invention;

FIG. 10 is an overview of a display screen illustrating a 3D image in a mobile terminal according to yet another embodiment of the present invention;

FIGS. 11A and 11B are overviews of display screens illustrating a 3D image in a mobile terminal according to another embodiment of the present invention;

FIG. 12 is an overview of a display screen illustrating a 3D image in a mobile terminal according to still another embodiment of the present invention;

FIG. 13 is an overview of a display screen illustrating a 3D image in a mobile terminal according to another embodiment of the present invention;

FIG. 14 is an overview of a display screen illustrating a 3D image in a mobile terminal according to still another embodiment of the present invention;

FIGS. 15A and 15B are overviews of display screens illustrating a 3D image in a mobile terminal according to another embodiment of the present invention;

FIGS. 16A to 16C are overviews of display screens illustrating a 3D image in a mobile terminal according to yet another embodiment of the present invention; and

FIGS. 17A to 17C are overviews of display screens illustrating a 3D image in a mobile terminal according to another embodiment of the present invention.

### DETAILED DESCRIPTION OF THE INVENTION

A mobile terminal according to an embodiment of the present disclosure will be described in detail with reference to the accompanying drawings. The suffixes ‘module’, ‘unit’ and ‘part’ may be used for elements and may be used together or interchangeably. Embodiments of the present invention may also be applicable to various types of terminals such as mobile phones, user equipment, smart phones, DTV, computers, digital broadcast terminals, personal digital assistants, portable multimedia players (PMP) and/or navigators. The following description refers to a mobile terminal, although such teachings may apply equally to other types of terminals such as stationary terminals that include digital TVs and desktop computers.

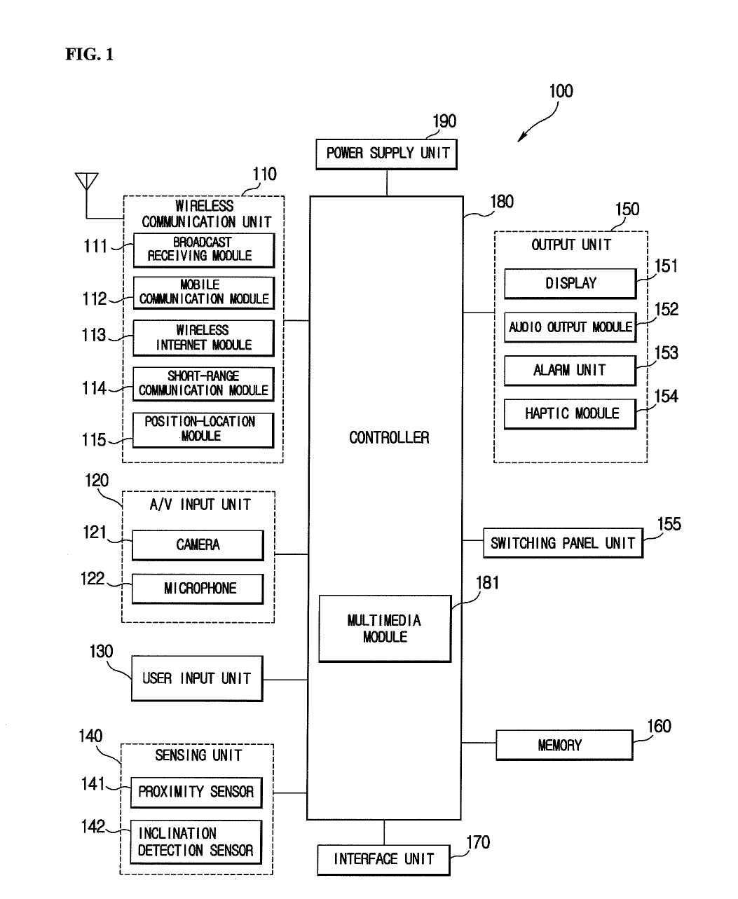

FIG. 1 is a block diagram of a mobile terminal 100 according to an embodiment of the present invention. The mobile terminal 100 includes various components. However, more or fewer components may alternatively be implemented. As shown in FIG. 1, the mobile terminal 100 includes a wireless communication unit 110, an audio/video (A/V) input unit 120, a user input unit 130, a sensing unit 140, an output unit 150, a switching panel unit 155, a memory 160, an interface unit 170, a controller 180 and a power supply unit 190.

In addition, the wireless communication unit 110 may be configured with several components and/or modules and in FIG. 1 includes a broadcast receiving module 111, a mobile communication module 112, a wireless Internet module 113, a short-range communication module 114 and a position-location module 115. The wireless communication unit 110 includes one or more components that permit wireless communication between the mobile terminal 100 and a wireless communication system or a network within which the mobile terminal 100 is located.

For non-mobile terminals, the wireless communication unit 110 may be replaced with a wire communication unit. In addition, the wireless communication unit 110 and the wire communication unit may be commonly referred to as a communication unit. Further, the broadcast receiving module 111 receives a broadcast signal and/or broadcast associated information from an external broadcast managing server via a broadcast channel. The broadcast channel may include a satellite channel and a terrestrial channel, and the broadcast managing server refers to a system that transmits a broadcast signal and/or broadcast associated information to a mobile terminal. The broadcasting signal can also include not only a TV broadcasting signal, a radio signal, and a data broadcasting signal, but also a broadcasting signal in which a TV broadcasting signal or a radio signal is combined with a data broadcasting signal.

Examples of broadcast associated information include information associated with a broadcast channel, a broadcast program, a broadcast service provider, etc. Further, the broadcast associated information may be provided through a mobile terminal, and in this instance, the broadcast associated information may be received by the mobile communication module 112. For example, broadcast associated information may include an electronic program guide (EPG) of the digital multimedia broadcasting (DMB) system and an electronic service guide (ESG) of the digital video broadcast-handheld (DVB-H) system.

In addition, the broadcast receiving module 111 can receive broadcast signals transmitted from various types of broadcast systems such as the digital multimedia broadcasting-terrestrial (DMB-T) system, the digital multimedia broadcasting-satellite (DMB-S) system, the digital video broadcast-handheld (DVB-H) system, a data broadcasting system known as the media forward link only (MediaFLO®) and integrated services digital broadcast-terrestrial (ISDB-T). The receiving of multicast signals may also be provided, and data received by the broadcast receiving module 111 can be stored in the memory 160, for example.

In addition, the mobile communication module 112 can communicate wireless signals with one or more network entities (e.g. a base station, an external terminal, a server). The signals may represent audio, video, multimedia, control signaling, and data, etc. Further, the wireless Internet module 113 can support Internet access for the mobile terminal 100, and may be internally or externally coupled to the mobile terminal 100. Suitable technologies for wireless Internet include, but are not limited to, WLAN (Wireless LAN) (Wi-Fi), Wibro (Wireless broadband), Wimax (World Interoperability for Microwave Access), and/or HSDPA (High Speed Downlink Packet Access). The wireless Internet module 113 may also be replaced with a wire Internet module in non-mobile terminals. The wireless Internet module 113 and the wire Internet module can thus be referred to as an Internet module.

Further, the short-range communication module 114 is a module that facilitates short-range communications. Suitable technologies for short-range communication include, but are not limited to, radio frequency identification (RFID), infrared data association (IrDA), ultra-wideband (UWB), as well as networking technologies such as Bluetooth and ZigBee. In addition, the position-location module 115 can identify or otherwise obtain a location of the mobile terminal 100, and may be provided using global positioning system (GPS) components that cooperate with associated satellites, network components, and/or combinations thereof.

Also, the position-location module 115 can precisely calculate current 3-D position information based on longitude, latitude and altitude by calculating distance information and precise time information from at least three satellites and then by applying triangulation to the calculated information. The location and time information can also be calculated using three satellites, and errors of the calculated location position and time information can then be amended or changed using another satellite. The position-location module 115 can also calculate speed information by continuously calculating a real-time current location.

In addition, the audio/video (A/V) input unit 120 provides audio or video signal input to the mobile terminal 100, and in FIG. 1 includes a camera 121 and a microphone 122. The camera 121 receives and processes image frames of still pictures and/or video, and the processed image frames can then be displayed on the display 151, stored in the memory 160 or transmitted to the outside through the wireless communication unit 110. At least two or more cameras 121 may also be provided in the mobile terminal according to use environment.

Further, the microphone 122 can receive an external audio signal while the mobile terminal 100 is in a particular mode such as a phone call mode, a recording mode and/or a voice recognition mode. The received audio signal is then processed and converted into digital data. Also, the mobile terminal 100, and in particular the A/V input unit 120, may include a noise removing algorithm or noise canceling algorithm to remove noise generated while receiving the external audio signal. The data generated by the A/V input unit 120 can also be stored in the memory 160, utilized by the output unit 150, and/or transmitted via one or more modules of the wireless communication unit 110. At least two or more microphones and/or cameras may also be provided.

In addition, the user input unit 130 generates input data responsive to user manipulation of an associated input device or devices. Examples of such devices include a keypad, a dome switch, a touchpad (e.g., static pressure/capacitance), a jog wheel and/or a jog switch. The sensing unit 140 can also provide status measurements of various aspects of the mobile terminal 100. For example, the sensing unit 140 can detect an opened/closed status or state of the mobile terminal 100, a relative positioning of components (e.g., a display and a keypad) of the mobile terminal 100, a change of position of the mobile terminal 100 or a component of the mobile terminal 100, a presence or absence of user contact with the mobile terminal 100, and/or an orientation or acceleration/deceleration of the mobile terminal 100.

The mobile terminal 100 may also be configured as a slide-type mobile terminal. In such a configuration, the sensing unit 140 can sense whether a sliding portion of the mobile terminal 100 is opened or closed. The sensing unit 140 can also sense a presence or absence of power provided by the power supply unit 190, a presence or absence of a coupling or other connection between the interface unit 170 and an external device, etc. In FIG. 1, the sensing unit 140 also includes a proximity sensor 141 and an inclination detection sensor 142. A gyro sensor and an acceleration sensor may be used for the inclination detection sensor 142.

In addition, the output unit 150 can generate an output relevant to a sight sense, an auditory sense, a tactile sense and/or the like. In FIG. 1, the output unit 150 includes a display (unit) 151, an audio output module 152, an alarm unit 153 and a haptic module 154. The display 151 can display information processed by the terminal 100. For example, when the terminal is in a call mode, the display 151 can display a user interface (UI) or a graphic user interface (GUI) associated with a call. If the mobile terminal 100 is in a video communication mode or a photograph mode, the display 151 can display a photographed and/or received picture, a UI or a GUI.

The display 151 may also include at least one of a liquid crystal display (LCD), a thin film transistor liquid crystal display (TFT LCD), an organic light-emitting diode (OLED), a flexible display, and a 3-dimensional display. Further, the display 151 may have a transparent or light-transmissive type configuration to enable an external environment to be seen through. This type of display is called a transparent display such as a transparent OLED (TOLED). A backside structure of the display 151 may also have the light-transmissive type configuration. In this configuration, a user can see an object located behind the terminal body through the area occupied by the display 151 of the terminal body.

At least two or more displays 151 may also be provided. For example, a plurality of displays may be provided on a single face of the terminal 100 by being built in one body or spaced apart from the single face. Alternatively, each of a plurality of displays may be provided on different faces of the terminal 100. In addition, if the display 151 and a sensor for detecting a touch action (hereinafter referred to as a touch sensor) are constructed in a mutual-layered structure (hereinafter referred to as a touch screen), the display 151 may be used as an input device as well as an output device. For example, the touch sensor 142 may include a touch film, a touch sheet, a touchpad and/or the like.

The touch sensor 142 can also convert a pressure applied to a specific portion of the display 151 or a variation of electrostatic capacity generated from a specific portion of the display 151 to an electric input signal. The touch sensor can also detect a pressure of a touch as well as a position and size of the touch. If a touch input is provided to the touch sensor 142, signal(s) corresponding to the touch input can be transferred to a touch controller. The touch controller can then process the signal(s) and transfer corresponding data to the controller 180. The controller 180 can therefore determine which portion of the display 151 is touched.

Referring again to FIG. 1, the proximity sensor 141 may be provided at an inner area of the mobile terminal wrapped by the touch screen or at a vicinity of the touch screen. Further, the proximity sensor 141 is a sensor capable of detecting an object approaching a predetermined detection surface or whether there is an object nearby using an electromagnetic force or infrared, dispensing with a mechanical contact. The proximity sensor 141 also has a longer life than that of a contact sensor, such that its utility is higher.

In addition, examples of the proximity sensor include a transmissive photo sensor, direct reflective photo sensor, a mirror reflective photo sensor, a high frequency oscillating proximity sensor, a capacitive proximity sensor, a magnetic proximity sensor, an infrared proximity sensor and the like. When the touch screen is capacitive type, the proximity of a pointer can be detected by changes of electric fields caused by proximity of the pointer. The touch screen (touch sensor) therefore may be classified as a proximity sensor.

Further, when a pointer is recognized to be proximately placed on a touch screen without touching the touch screen is called a “proximity touch” and when the pointer completely touches the touch screen is called a “contact touch”. The position proximity-touched by the pointer on the touch screen is a position vertically corresponded by the pointer to the touch screen when the pointer proximity-touches the touch screen. The proximity sensor 141 can also detect the proximity touch and proximity touch pattern (e.g., proximity touch distance, proximity touch direction, proximity touch speed, proximity touch time, proximity touch position and proximity touch mobile state, etc.). Information corresponding to the detected proximity touch operation and proximity touch pattern may also be displayed on the touch screen.

Further, the audio output module 152 outputs audio data that is received from the wireless communication unit 110 in a call signal reception mode, a call mode, a recording mode, a voice recognition mode, a broadcast receiving mode and/or the like. The audio output module 152 can also output audio data stored in the memory 160, and output an audio signal relevant to a function (e.g., a call signal receiving sound, a message receiving sound, etc.) performed by the mobile terminal 100. The audio output module 152 may include a receiver, a speaker, a buzzer and/or the like.

In addition, the alarm unit 153 outputs a signal for announcing an event occurrence of the mobile terminal 100 such as a call signal reception, a message reception, a key signal input, a touch input and/or the like. The alarm unit 153 can output a signal for announcing an event using vibration or the like as well as a video and/or an audio signal. For example, the video signal may be output via the display 151, and the audio signal may be output via the audio output module 152. Thus, the display 151 and/or the audio output module 152 may be classified as part of the alarm unit 153.

In addition, the haptic module 154 uses/outputs various haptic effects that can be sensed by a user. For example, vibration is a representative example of a haptic effect. The strength and pattern of the vibration generated from the haptic module 154 may also be controlled. For example, vibrations differing from each other may be output in a manner of being synthesized together or may be sequentially output.

The haptic module 154 can also generate various haptic effects including a vibration, an effect caused by such a stimulus as a pin array vertically moving against a contact skin surface, a jet power of air via outlet, a suction power of air via inlet, a skim on a skin surface, a contact of an electrode, an electrostatic power and the like, and/or an effect by hot/cold sense reproduction using an endothermic or exothermic device as well as the vibration. Further, the haptic module 154 can provide the haptic effect via direct contact, and enable a user to experience the haptic effect via muscular sense of a finger, an arm and/or the like. Two or more haptic modules 154 may also be provided according to a configuration of the mobile terminal 100.

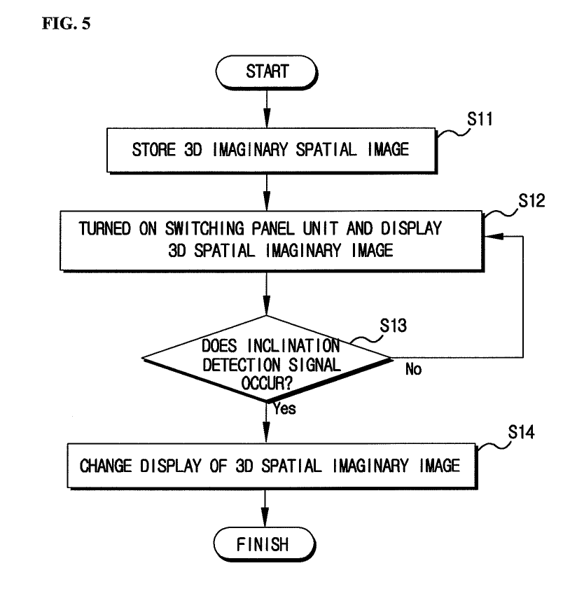

Next, the switching panel unit 155 is a constituent element for expressing a 3D image using binocular disparity, the function of which will be described in more detail later with reference to FIG. 3.

Referring again to FIG. 1, the memory 160 stores a program for operations of the controller 180, temporarily stores input/output data (e.g., phonebook, message, still picture, moving picture, etc.), data of vibration and sound in various patterns output when a touch input to the touch screen is detected, etc. The memory 160 may also include at least one of a flash memory, a hard disk, a multimedia card micro type memory, a card type memory (e.g., SD memory, XD memory, etc.), a random access memory (RAM), a static random access memory (SRAM), a read-only memory (ROM), an electrically erasable programmable read-only memory, a programmable read-only memory, a magnetic memory, a magnetic disk, an optical disk, and/or the like. The mobile terminal 100 may also operate in association with a web storage that performs a storage function of the memory 160 in the Internet.

Further, the interface unit 170 functions as a passage to external devices connected to the mobile terminal 100. In more detail, the interface unit 170 may receive data from an external device, and/or be supplied with a power such that the power can be delivered to elements within the mobile terminal 100. The interface unit 170 can also enable data to be transferred to an external device connected to the mobile terminal 100. In addition, the interface unit 170 may include a wire/wireless headset port, an external charger port, a wire/wireless data port, a memory card port, a port for coupling to a device having an identity module, an audio input/output (I/O) port, a video input/output (I/O) port, an earphone port and/or the like.

In addition, the identity module may be a chip or card that stores various kinds of information for authenticating use of the mobile terminal 100. The identify module may also include a user identity module (UIM), a subscriber identity module (SIM), a universal subscriber identity module (USIM) and/or the like. A device provided with the above identity module (hereinafter referred to as an identity device) may also be manufactured in the form of a smart card. The identity device may also be connected to the mobile terminal 100 via the port.

In addition, the interface unit 170 functions a passage for supplying a power to the mobile terminal 100 from a cradle that is connected to the mobile terminal 100, and function as a passage for delivering various command signals, which are input from the cradle by a user, to the mobile terminal 100. Various command signals input from the cradle or the power can also work as a signal for recognizing that the mobile terminal 100 is correctly loaded in the cradle.

Further, the controller 180 controls the overall operations of the mobile terminal 100. For example, the controller 180 performs control and processing relevant to a voice call, a data communication, a video conference and/or the like. In FIG. 1, the controller 180 also includes a multimedia module 181 for multimedia playback. The multimedia module 181 may also be implemented within the controller 180 or be configured separately from the controller 180. In addition, the controller 180 can perform pattern recognizing processing for recognizing a handwriting input performed on the touch screen as a character an/or recognizing a picture drawing input performed on the touch screen as an image.

Further, the power supply unit 190 receives an external or internal power and then supplies the power required for operations of the respective elements under control of the controller 180. In addition, embodiments of the present invention may be implemented within a recording medium that can be read by a computer or a computer-like device using software, hardware or combination thereof.

According to a hardware implementation, arrangements and embodiments may be implemented using at least one of application specific integrated circuits (ASICs), digital signal processors (DSPs), digital signal processing devices DSPDs), programmable logic devices (PLDs), field programmable gate arrays (FPGAs), processors, controllers, microcontrollers, microprocessors and electrical units for performing other functions. In some cases, embodiments may be implemented by the controller 180.

For a software implementation, arrangements and embodiments described herein may be implemented with separate software modules, such as procedures and functions, each of which may perform one or more of the functions and operations described herein. Software codes may be implemented with a software application written in any suitable programming language and may be stored in memory such as the memory 160, and may be executed by the controller 180 or processor.

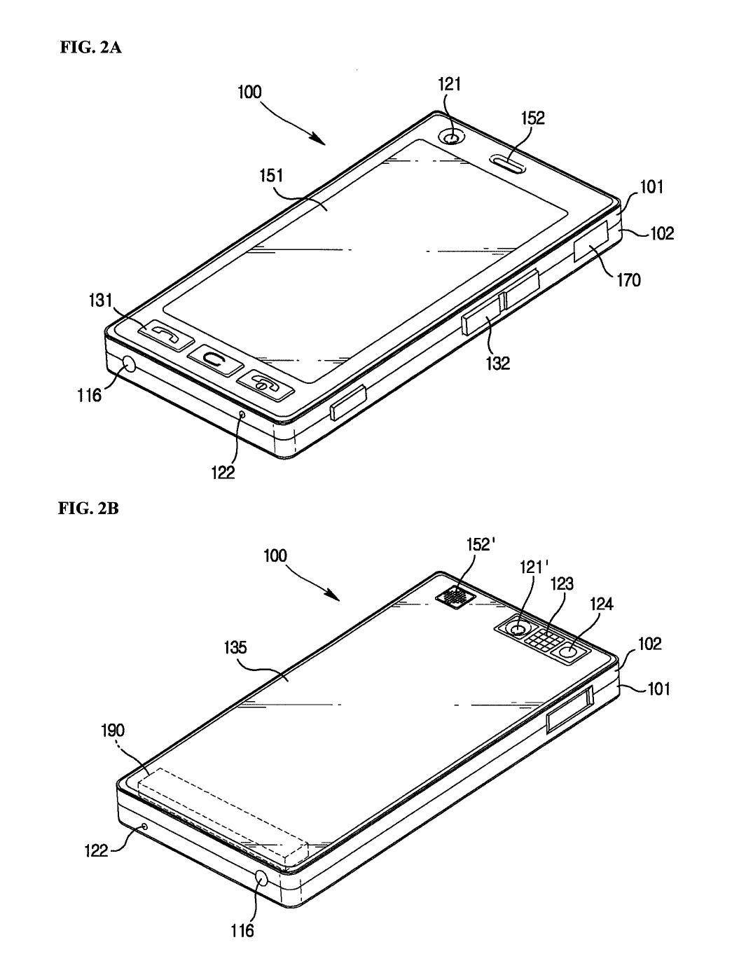

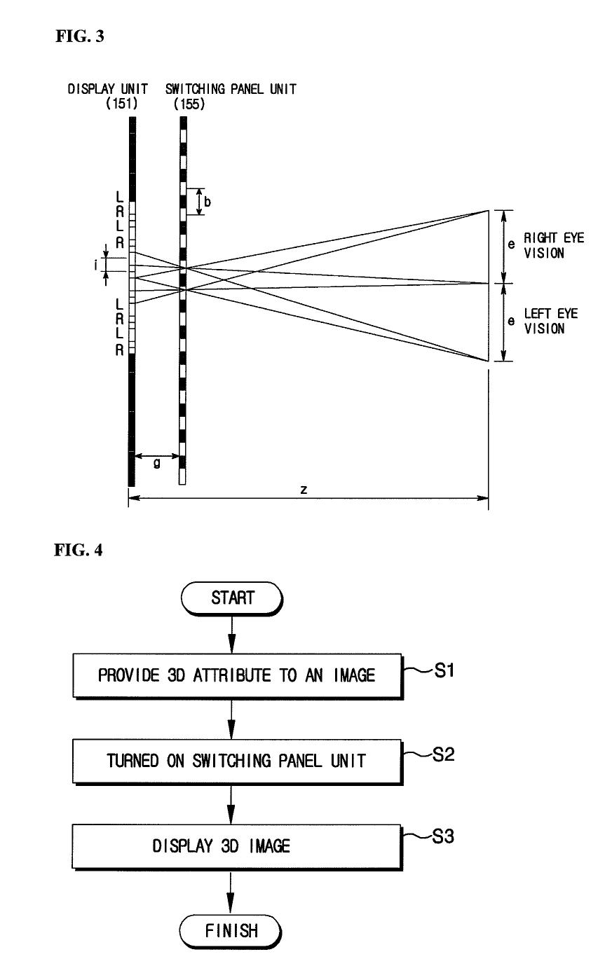

Next, FIG. 2A is a front perspective view of a mobile terminal according to an embodiment of the present invention. Other embodiments, configurations and arrangements may also be provided. The mobile terminal 100 shown in FIG. 2A is a bar type terminal body. However, embodiments of the present invention include all types of mobile terminals such a folder-type, a slide-type, a bar-type, a rotational-type, a swing-type and/or combinations thereof.

The body of the terminal 100 may also include a case (casing, housing, cover, etc.) that forms an exterior of the terminal. In FIG. 2A, the case is divided into a front case 101 and a rear case 102. Various electric/electronic parts are also provided in a space between the front case 101 and the rear case 102. A middle case may be further provided between the front case 101 and the rear case 102. Further, the cases may be formed by injection molding of synthetic resin or be formed of metal substance such as stainless steel (STS), titanium (Ti) or the like, for example.

The display 151, the audio output unit 152, the camera 121, user input units 130/131/132, the microphone 122, the interface unit 170 and the like may be provided on the terminal body, and more particularly on the front case 101. The display 151 can also occupy most of a main face of the front case 101, and the audio output module 152 and the camera 121 can be provided at an area adjacent to one end portion of the display 151, while the user input unit 131 and the microphone 122 are provided at another area adjacent to the other end portion of the display 151. The user input unit 132 and the interface unit 170 may also be provided on lateral sides of the front case 101 and a rear case 102.

In addition, the user input unit 130 may receive a command for controlling an operation of the mobile terminal 100, and include a plurality of manipulating units 131 and 132. The manipulating units 131 and 132 can be generally called a manipulating portion and adopt any mechanism including a tactile manner that enables a user to perform a manipulation action by experiencing a tactile feeling.

The contents input by the first manipulating unit 131 and/or the second manipulating unit 132 may be diversely set. For example, a command such as start, end, scroll and/or the like may be input to the first manipulating unit 131, and a command for a volume adjustment of sound output from the audio output unit 152, a command for switching to a touch recognizing mode of the display 151 or the like may be input to the second manipulating unit 132.

Next, FIG. 2B is a perspective diagram of a backside of the mobile terminal 100 shown in FIG. 2A. Other embodiments, configurations and arrangements may also be provided. As shown in FIG. 2B, a camera 121′ is additionally provided on a backside of the terminal body, and more particularly on the rear case 102. The camera 121′ may have a photographing direction that is substantially opposite to a photographing direction of the camera 121 (shown in FIG. 2A) and may have pixels differing from pixels of the camera 121.

For example, the camera 121 may have a lower number of pixels to capture and transmit a picture of user face for a video call, while the camera 121′ may have a greater number of pixels for capturing a general subject for photography without transmitting the captured subject. Each of the cameras 121 and 121′ may also be installed on the terminal body to be rotated and/or popped up.

A flash 123 and a mirror 124 are also additionally provided adjacent to the camera 121′. In more detail, the flash 123 projects light toward a subject when photographing the subject using the camera 121′. If a user wants to take a picture of the user (self-photography) using the camera 121′, the mirror 124 allows the user to view a user face reflected by the mirror 124.

An additional audio output unit 152′ is also provided on the backside of the terminal body, and thus can implement a stereo function together with the audio output unit 152 shown in FIG. 2A and be used for implementation of a speakerphone mode in talking over the terminal. A broadcast signal receiving antenna 116 is also provided at the lateral side of the terminal body as well as an antenna for communication or the like. The antenna 116 may be considered a portion of the broadcast receiving module 111 shown in FIG. 1 and may be retractably provided on the terminal body.

In addition, the power supply unit 190 for supplying a power to the mobile terminal 100 is provided to the terminal body. The power supply unit 190 may also be embedded within the terminal body. Alternatively, the power supply unit 190 may be detachably and attachably connected to the terminal body.

In addition, FIG. 2B also shows a touchpad 135 for detecting a touch that is additionally provided on the rear case 102. The touchpad 135 may be configured in a light transmissive type like the display 151. If the display 151 outputs visual information from both faces, the display 151 may recognize visual information via the touchpad 135 as well. Further, the information output from both of the faces may be controlled by the touchpad 135. Alternatively, a display may be further provided to the touchpad 135 so that a touch screen may also be provided to the rear case 102.

Also, the touchpad 135 may be activated by interconnecting with the display 151 of the front case 101. The touchpad 135 may also be provided in rear of the display 151 in parallel to one another, and have a size equal to or smaller than a size of the display 151.

Next, FIG. 3 is a schematic view explaining a principle of displaying a 3D image using binocular disparity in a mobile terminal according to an embodiment of the present invention. In more detail, a method for displaying a 3D image may be divided into two methods. For example, a first method is a stereoscopic 3D display that needs spectacles, and the second method is an auto-stereoscopic 3D display that does not need spectacles using binocular disparity. The auto-stereoscopic 3D display is also the same as the stereoscopic 3D display in that both ways can provide a 3D feeling using binocular disparity, but is differentiated from the stereoscopic 3D display in that special spectacles are not needed.

Next, one of the principles of auto-stereoscopic 3D display will be explained with reference to FIG. 3. Referring to FIG. 3, the switching panel unit 155 is attached on an upper surface of the display 155 in order to display a 3-D real image. The switching panel unit 155 also uses binocular disparity to allow an image to be seen as a 3D image. In more detail, binocular disparity defines a visual difference of an object seen by a left eye and a right eye of a user.

That is, if an image (R) seen through a right eye and an image (L) seen through a left eye are combined, the combined image is seen as a 3D image. To this end, an image is divided into two images, one seen by a right eye and the other seen by a left eye, and the left image (L) and the right image (R) are combined per pixel unit and displayed on one screen.

Thereafter, the two eyes of the user are made to divisively watch a pixel unit image by the left image and a pixel unit image by the right image, and thus the image is seen as a 3D image. A method of combining two images can use an interpolation method but may differ based on image-forming methods. In addition, the reference characters “b” in FIG. 3 defines a barrier gap of the switching panel unit 155, “g” represents a distance between the switching panel unit 155 and the display 151, and “z” refers to a distance between a user and the display 151.

Also, when two images are combined per pixel unit (L, R) as illustrated in FIG. 3, the switching panel unit 155 can be operated in such a manner in which the vision of a right eye is received by pixels contained in the right image and the vision of the left eye is received by pixels contained in the left image. The switching panel unit 155 can also separate an incident vision by being turned on when a 3D image (a 3D real image) is to be expressed. Furthermore, the switching panel unit 155 does not separate the incident vision and just lets it pass by being turned off, when a 2D image is to be expressed. Therefore, binocular disparity does not occur when the switching panel unit 155 is turned off.

In addition, FIG. 3 is a method for displaying a 3D image using binocular disparity according to the Parallex Barrier method. However, the present invention is not limited to the Parallex Barrier method and may use such methods as lenticular method and stereoscopic method (a method of viewing a 3D image through glasses), in addition to the Parallex Barrier method.

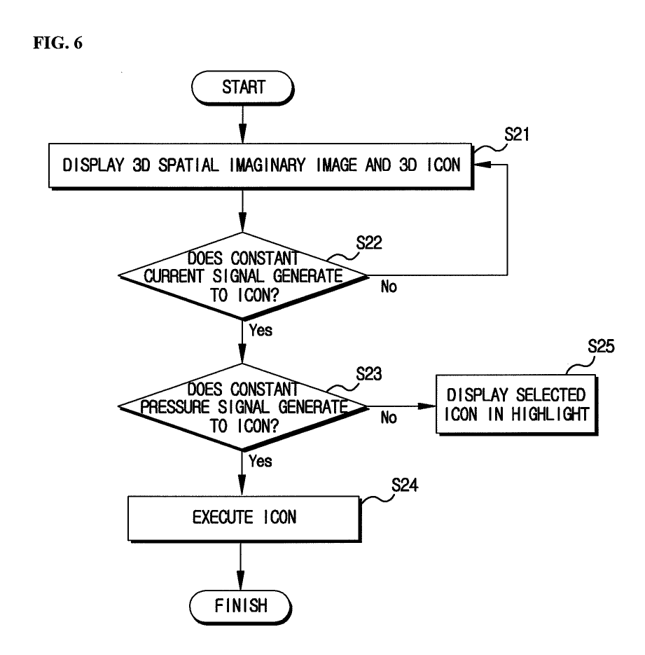

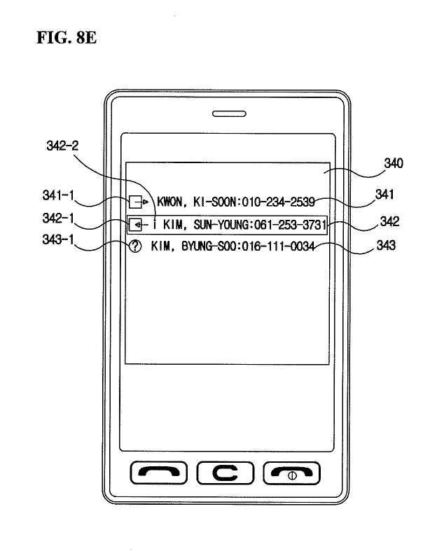

Next, a method for displaying a 3D image using binocular disparity in a mobile terminal according to an embodiment of the present invention will be described with reference to the flowcharts of FIGS. 4-6. Referring to FIG. 4, which illustrates a first embodiment of the present invention, the user provides 3D attributes to an image through the user input unit (S1). The set 3D attributes may include an adjustment of depth, swinging of light, providing of light, change of surface color, providing of a 3D color, etc. The setting of the 3D attribute will be further described in more detail later with reference to FIGS. 8A-14. Further, the image may include an icon, an image object, a text, an emoticon, a moving picture image and a still image.

Referring again to FIG. 4, when the condition is met after the 3D attribute is provided, the switching panel unit 155 is turned on (S2), and the controller 180 displays a left eye image and a right eye image on the display 151 (S3). At this time, the left eye image and the right eye image may be adjusted by a user setting or be changed in display. As a result, a 3D image using binocular disparity can be displayed on the display 151 according to the user setting.

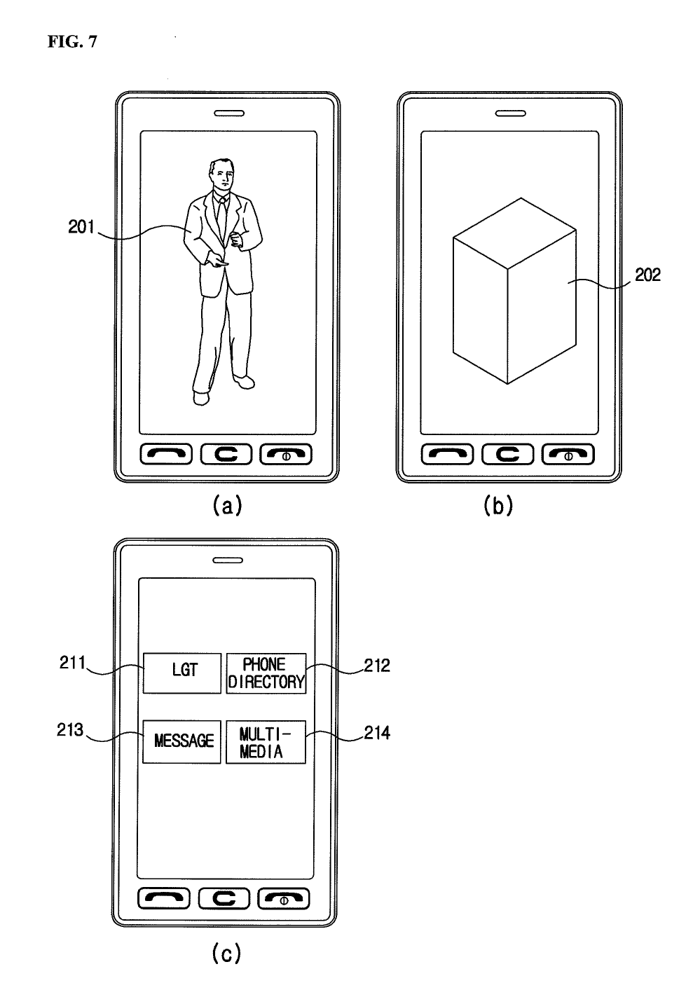

Next, FIG. 5 is a flowchart illustrating a second embodiment of the present invention. Referring to FIG. 5, the memory 160 stores a 3D imaginary spatial image (S11). Also, the 3D imaginary spatial image includes the left eye image and the right eye image, and as the switching panel unit 155 is turned on, the left eye image and the right eye image are respectively viewed through a left eye and a right eye of the user to complete the 3D image. That is, when the 3D imaginary spatial image is displayed on the display 151, which is a touch screen, the switching panel unit 155 is turned on to display the image as a 3D image (S12).

At this time, only a part of the imaginary spatial image is displayed on the touch screen. Under this circumstance, the controller 180 checks if an inclination detection signal of the mobile terminal has been generated by the inclination detection sensor 142 (S13). When the inclination detection signal is generated (Yes in S13), the controller 180 changes the display of the 3D imaginary spatial image (S14).

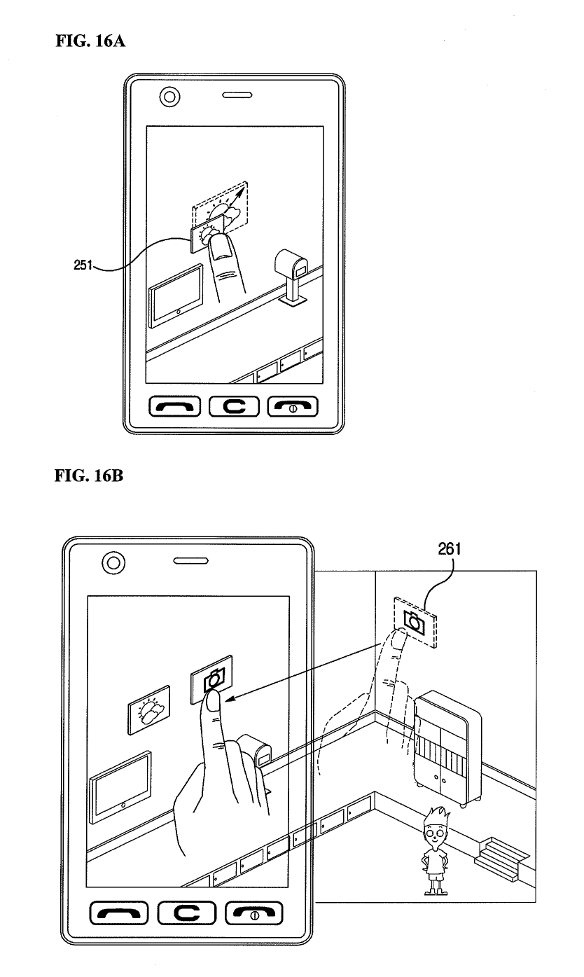

Thus, according to the second embodiment of the present invention, a tilting of a mobile terminal by the user enables display of a not-yet-displayed 3D imaginary spatial image on the display 151. A more detailed explanation of the second embodiment will be described later with reference to FIGS. 15A and 15B.

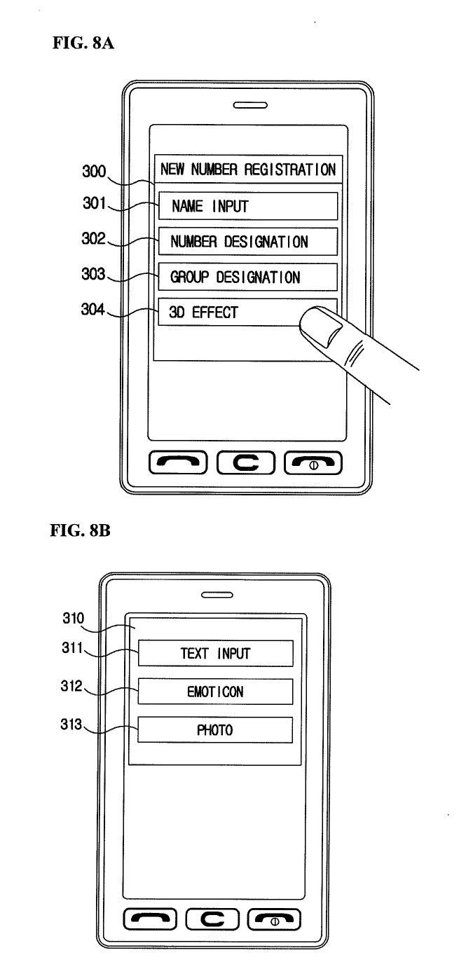

Next, FIG. 6 is a flowchart illustrating a third embodiment of the present invention. Referring to FIG. 6, the memory 160 stores a 3D imaginary spatial image and the 3D imaginary spatial image includes a 3D icon. The 3D imaginary spatial image and the 3D icon are also displayed on the touch screen (S21). Further, the 3D imaginary spatial image and the 3D icon include the left eye image and the right eye image, and as the switching panel unit 155 is turned on, the left eye image and the right eye image can be respectively viewed through a left eye and a right eye of the user to complete the 3D image. That is, as discussed above, the switching panel unit 155 is turned on to allow the 3D image to be displayed as a real 3D image.

At this time, only a part of the 3D imaginary spatial image is displayed on the touch screen. Meanwhile, the touch screen is a constant current constant voltage combined touch screen capable of receiving all the constant current and constant voltage inputs. When only constant current is generated for one of the displayed icons (Yes in S22), the controller 180 successively monitors whether a constant voltage input signal has been generated (S23). If the constant voltage input signal has been generated (Yes in S23), the selected icon is executed (S24). If the constant voltage input signal has not been generated and only the constant current input signal has been generated (No in S23), the selected icon is displayed in highlight (S25). The constant current signal can be a touch signal and the constant voltage signal can be pressure touch signal.

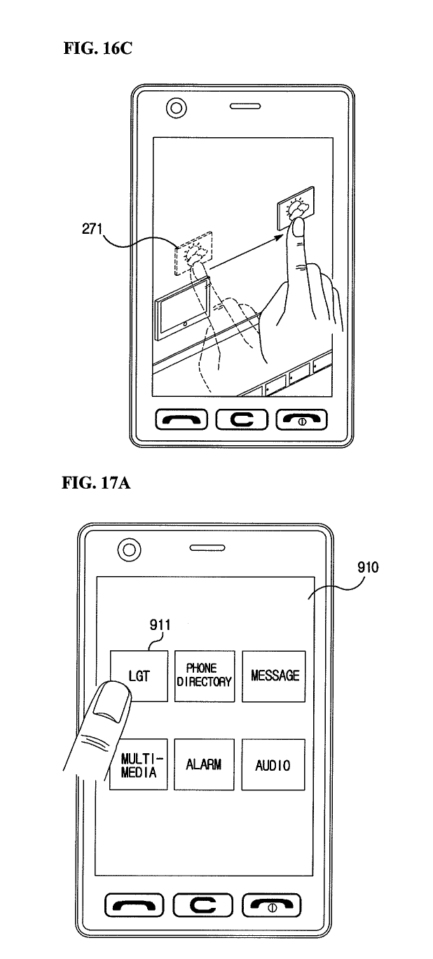

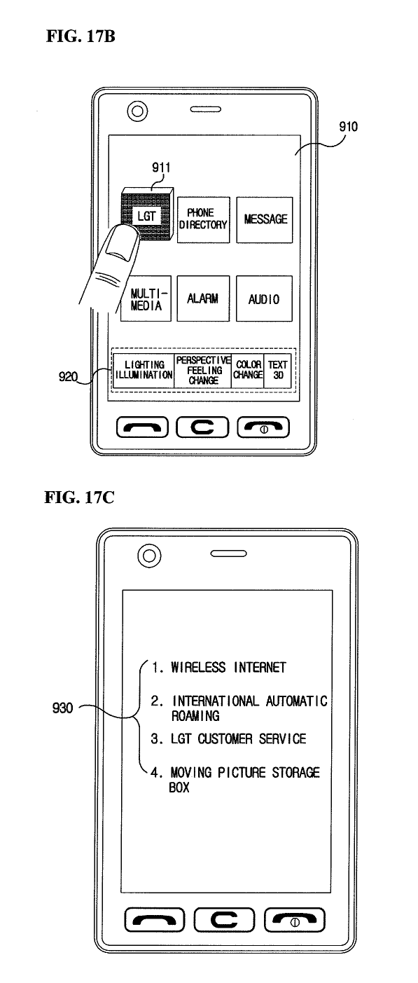

The highlighting method may also be determined by a user setting. Thus, according to the third embodiment of the present invention, the user can use a constant current constant voltage combined touch screen to selectively execute and highlight the 3D icon by the switching panel unit. A detailed explanation with regard to the third embodiment will be provided later with reference to FIGS. 16A and 17C.

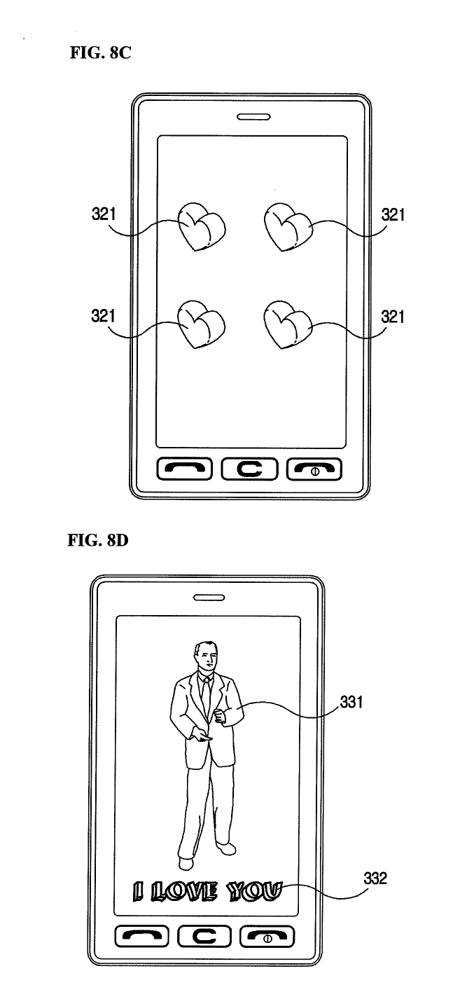

Next, an image applicable to a method for display a 3D image using binocular disparity in a mobile terminal according to an embodiment of the present invention will be described with reference to FIG. 7. As illustrated in FIG. 7, an image may be a still or stationary image 201 (see FIG. 7(a)), a 3D object (see FIG. 7(b)) and menu icons 211-214 (see FIG. 7(c)).

The controller 18 can also divisively generate an image pre-stored in the memory into a left eye image and a right eye image and display the images on the display 151. Further, the controller 180 can controllably turn on the switching panel unit 155 to allow the left eye image to be emitted to a left eye, and the right eye image to be emitted to a right eye, whereby the user can view a 3D image caused by binocular disparity. In addition, the 3D image according to embodiments of the present invention can also include a text object, an emoticon, an avatar and a moving picture image, the details of which will be described with reference to FIGS. 8A-14.

Next, a method for displaying a 3D image using binocular disparity in a mobile terminal according to the first embodiment of the present invention will be described with reference to FIGS. 8A-14. In more detail, FIGS. 8A-8E include overviews of display screens illustrating a first example of displaying a 3D image using binocular disparity in a mobile terminal.

As shown, FIG. 8A illustrates a phone directory registration screen 300 including a name input block 301, a number input block 302, a group designation block 303 and a 3D effect block 304. When the user selects the 3D effect block 304 through the user input unit 130, the controller 180 displays a 3D effect set-up screen 310 on the display 151 as illustrated in FIG. 8B. Further, the 3D effect set-up screen 310 includes a text input block 311, an emoticon block 312 and a photo block 313 in this example.

When the user selects the text input block 311 to input a predetermined character, a character in 3D image is generated, and when a call signal is received from or transmitted to the telephone number registered with the phone directory registration screen, the controller 180 turns on the switching panel unit 155 and displays the character on the display 151 in a 3D image. When the user selects the emoticon block 312 to select a predetermined emoticon, an emoticon in a 3D image is generated, and when a call signal is received from or transmitted to the telephone number registered with the phone directory registration screen, the controller 180 turns on the switching panel unit 155 and displays the emoticon on the display 151 in a 3D image.

In addition, when the user selects the photo block 313 to select a predetermined image, the controller 180 generates a left eye image and a right eye image from the image, and when a call signal is received from or transmitted to the telephone number registered with the phone directory registration screen, the left eye image and the right eye image are expressed to allow the selected image to be displayed on the display 151 in a 3D image by turning on the switching panel unit 155.

Next, FIG. 8C illustrates a screen that is displayed including emoticons 321 set by the user for a predetermined call signal. That is, when the user selects a predetermined emoticon 321 through the emoticon block 312 for a received text message from the registered phone number or for a transmitted text message to the registered phone number, the controller 180 turns on the switching panel unit 155 and displays the 3D emoticon on the display 151, whereby a 3D emoticon 321 is displayed.

Next, FIG. 8D illustrates a screen on which an image 331 selected by the user and a character or text 332 are simultaneously displayed. That is, when the user selects a predetermined character or image through the text input block 311 and the photo block 313, and when a text message or call signal is received from or transmitted to the registered telephone number, the controller 180 displays the text 332 and the image 331 as 3D images.

Meanwhile, FIG. 8E illustrates a communication list screen 340 including a plurality of phone number items 341-343. Also, the controller 180 displays each item with a reception identifier 341-1, a transmission identifier 342-1 and a missing identifier 343-1. However, if a 3D effect is set for the items, the controller 180 displays an identifier 342-2 to identify the 3D effect is set.

In addition, in FIG. 8E, the controller 180 can differently display a backdrop color of an item that is set with the 3D effect. That is, the controller 180 can distinctively display an item that is set with the 3D effect on the communication list screen 340 from other items. In the present example, although an item set with a 3D effect on the communication list screen has been explained, it is not limited thereto. For instance, a short key screen and a message list screen may be also applied.

Thus, according to the first example, when a new item (e.g., a person's name) is stored in a phone directory, and when a 3D effect is set and a call signal is received from a phone number set with the 3D effect, the controller 180 turns on the switching panel unit 155 and thus outputs a 3D image to the display 151 to improve the visibility.

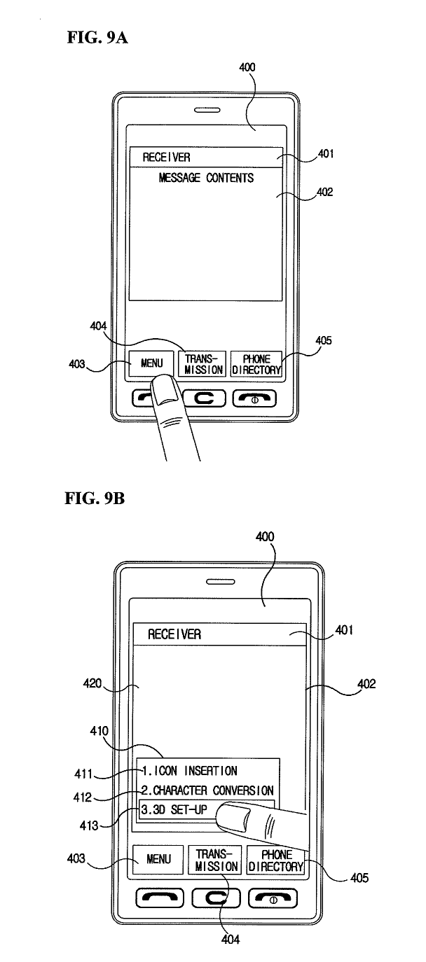

Next, FIGS. 9A-9D include overviews of display screens displaying a 3D image using binocular disparity in a mobile terminal according to the first embodiment of the present invention. As shown, FIG. 9A illustrates a character message preparation screen 400 including a recipient designation block 401, a message preparation block 402, a menu icon 403, a transmission icon 404 and a phone directory icon 405.

As shown in FIG. 9B, when the user selects the menu icon 403, the controller 180 displays a menu window 410 in an overlapping manner on the message preparation screen 400. In this example, the menu window 410 also includes an icon insertion item 411, a word conversion item 412 and a 3D set-up item 413. When the user selects a 3D set-up item 413, designates a part 420 of the character message preparation screen and provides a 3D effect thereto, the controller 180 displays part of the characters in the character message with a left eye image and a right eye image, and turns on the switching panel unit 155 to display 3D images as shown in FIG. 9C. That is, part of the input characters is provided with 3D attribute information.

When the user selects the transmission icon 404, the controller 180 transmits preparation-completed character message and the 3D attribute information to a receiver terminal (e.g., at least one other terminal). When the receiver terminal receives the character message and the 3D attribute information, and displays the character message, part of the character message may be displayed as a 3D image as designated by the sender.

Meanwhile, FIG. 9D illustrates a message list screen 400 of the receiver terminal and including a plurality of message items 431-433. As shown, one of the message items is displayed with a 3D attribute icon 435. Further, the 3D icon 435 indicates that the message item includes the 3D attribute information. Thus, by displaying the 3D attribute icon 435, the user can verify whether a character message is a 3D character message prior to checking the message.

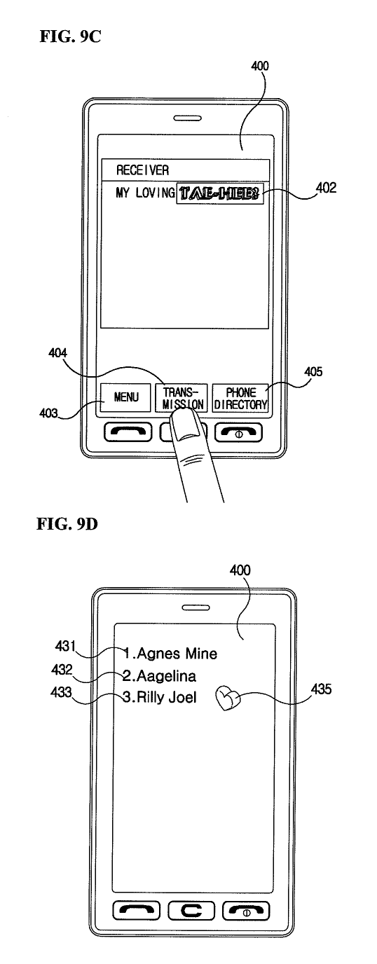

Next, FIG. 10 is an overview of a display screen illustrating a third example of displaying a 3D image using binocular disparity in a mobile terminal according to the first embodiment of the present invention. As shown, FIG. 10 illustrates wallpaper 500 including a watch widget 501, a weather widget 502, and a memo widget 503. In addition, an instant file or a menu icon may be further displayed.

Under this circumstance, the user can select one of the widgets and set a 3D attribute. The method of setting the 3D attribute may utilize that of the first example. Once the 3D attribute is provided, the controller 180 generates a left eye image and a right eye image of the selected icon, and turns on the switching panel unit 155. Then, the selected icon is displayed as a 3D image.

Although the third example has described the setting of a 3D attribute to the widgets displayed on the wallpaper 500, the description is not limited thereto, and the menu screen can also be set for the 3D attribute to the menu icon. Furthermore, although the third example has described the 3D attribute to one of the widgets displayed on the wallpaper, the description is not limited thereto, and 3D attribute information may be provided to all widgets displayed on the wallpaper 500.

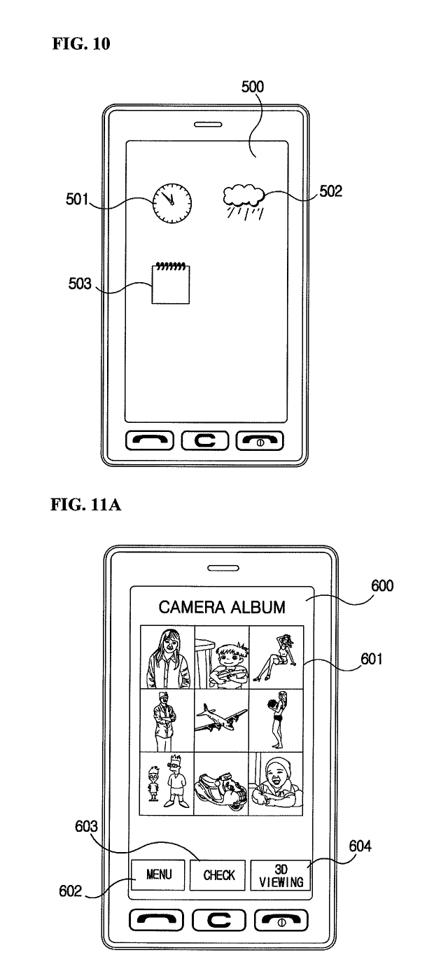

Next, FIGS. 11A and 11B are overviews of display screens illustrating a fourth example of displaying a 3D image using binocular disparity in a mobile terminal according to the first embodiment of the present invention. As shown, FIG. 11A illustrates a camera album screen 600 including a plurality of thumbnails 601, a menu icon 602, a check icon 603 and a 3D view icon 604. When the user selects one of the thumbnails and then selects the 3D view icon 604, the selected image is displayed as shown in FIG. 11B. At this time, the controller 180 generates a left eye image and a right eye image relative to the selected image, and turns on the switching panel unit 155, whereby an image (photo) in 3D image is displayed. Meanwhile, the 3D effect may include a light illumination, a rotation and depth adjustment.

Although the fourth example has described the application to the still image (photo), the description is not limited thereto. That is, the example may be applied to a moving picture image. Thus, according to the fourth example, the user can provide a 3D attribute to the still (stationary) or moving images.

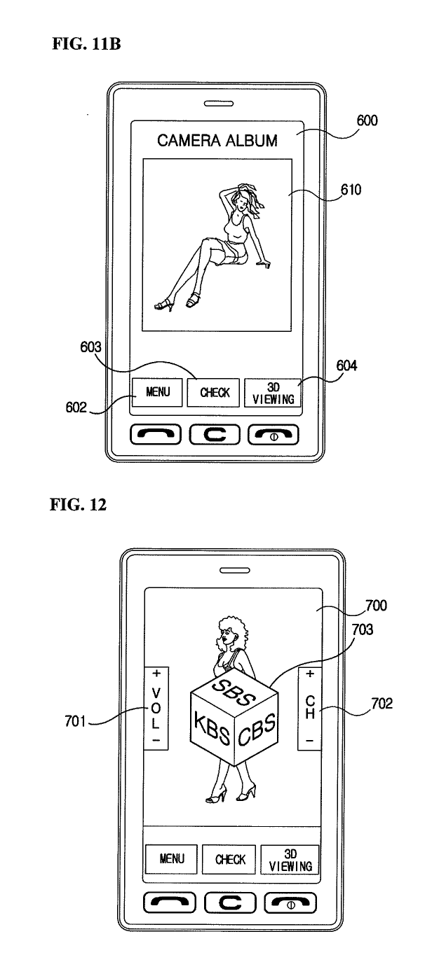

Next, FIG. 12 is an overview of a display screen illustrating a fifth example of displaying a 3D image using binocular disparity in a mobile terminal according to the first embodiment of the present invention. As shown, FIG. 12 illustrates a broadcasting data reception screen 700 including a volume control icon 701, a channel control icon 702 and a 3D preferred channel 3D icon 703. That is, when the user provides a 3D effect to the preferred channel, the 3D preferred channel 3D icon 703 may be overlapped on the broadcasting data reception screen and displayed. The 3D preferred channel 3D icon 703 can also be rotated by a user setting or colors thereof may be sequentially changed.

Although the fifth example has described the preferred channel icon being displayed as a 3D image, the description is not limited thereto. That is, the example may be applied to a situation where one of the broadcasting menus is selected and displayed as a 3D image.

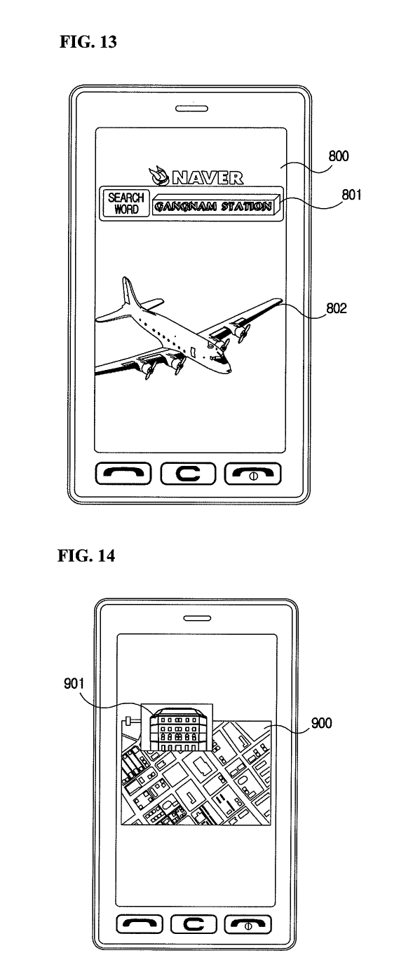

Next, FIG. 13 is an overview of a display screen illustrating a sixth example of displaying a 3D image using binocular disparity in a mobile terminal according to the first embodiment of the present invention. As shown, FIG. 13 illustrates a webpage screen 800. That is, the mobile terminal 100 can connect to an external server through the wireless communication unit 110, receive a webpage data from the external server and display the webpage screen 800 on the display 151. The user can then select a part of the webpage screen 800 and provide a 3D effect.

Further, the sixth example illustrates a 3D effect to a search word input block 801 and a particular image block 802. As a result, the controller 180 can generate a left eye image and a right eye image to the search word input block 801 and the image block 802, and turn on the switching panel unit 155 to display a 3D image. Thus, according to the sixth example, it is possible to configure a more visible webpage screen based on the user option.

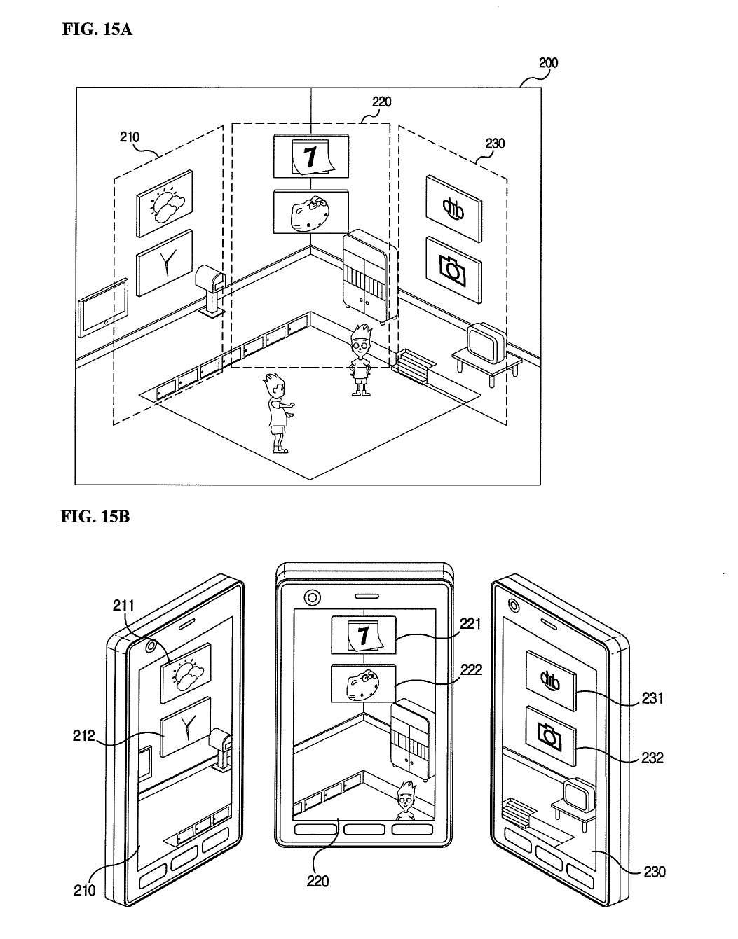

Next, FIG. 14 is an overview of a display screen illustrating a seventh example of displaying a 3D image using binocular disparity in a mobile terminal according to the first embodiment of the present invention. As shown, FIG. 14 illustrates a map screen 900. That is, the controller 180 displays the map screen 900 on the display 151 using map data pre-stored in the memory 160 of the mobile terminal 100. The map screen 900 may further include a predetermined building, a geographical name, and image data on a scenic spot (e.g., icon data. 901). At this time, the user may provide a 3D effect on the image data.

As shown in FIG. 14, the image data 901 can be displayed as a 3D image. That is, the controller 180 can generate a left eye image and a right eye image of the image data 901, and turn on the switching panel unit 155 to display a 3D image. Thus, according to the seventh example, it is possible to configure a web screen with a better visibility.

Next, a method of displaying a 3D image using binocular disparity in a mobile terminal according to the second and third embodiments of the present invention will be described in detail with reference to FIGS. 15A-17C. That is, FIGS. 15A and 15B include overviews of display screens illustrating an eighth example of displaying a 3D image using binocular disparity in a mobile terminal according to the second embodiment of the present invention.

In more detail, FIG. 15A illustrates a 3D imaginary spatial image 200 according to an embodiment of the present disclosure. Further, the 3D imaginary spatial image 200 is an image larger than the display as illustrated in FIGS. 15A and 15B. Therefore, the display only includes part of the 3D imaginary spatial image 200. In addition, the 3D imaginary spatial image displayed on the display may vary in response to an inclination signal received through the inclination detection sensor 141 in the mobile terminal 100. That is, when the mobile terminal 100 is tilted to the left hand side, the controller 180 displays a portion of reference numeral 210 on the display 151, when the mobile terminal 100 is tilted to the right hand side, the controller 180 displays a portion of reference numeral 230 on the display 151, and when the mobile terminal is centrally positioned, the controller 180 displays a portion of reference numeral 220 on the display 151.

Meanwhile, the 3D imaginary spatial image 200 may be displayed with at least one icon. In more detail, assuming the 3D imaginary spatial image 200 is wallpaper (e.g., a screen graphic), the icon may be a widget icon or an instant file icon. As shown in FIG. 15B, when the mobile terminal 100 is tilted to the left hand side, the controller 180 displays the 3D imaginary spatial image 210 with a weather widget 211 and a watch widget 212, when the mobile terminal 100 is tilted to the right hand side, the controller 180 displays a 3D imaginary spatial image 230 with a DMB icon 231 and a camera icon 232, when the mobile terminal 100 is centrally positioned (none or very little tilt in which a default screen id displayed), the controller 180 displays a 3D imaginary spatial image 220 with a calendar widget 221 and an avatar 222. Although the eighth example describes a 3D imaginary spatial image capable as wallpaper, the description is not limited thereto. That is, the example may also be applied to a menu screen, a web screen, e-book data, etc.

Next, FIGS. 16A-16C include overviews of display screens illustrating a ninth example of displaying a 3D image using binocular disparity in a mobile terminal according to the third embodiment of the present invention. In more detail, FIGS. 16A-16C illustrate examples of changing icon attributes displayed on the wallpaper.

In particular, FIG. 16A illustrates changing a size of an icon displayed on the wallpaper. As shown in FIG. 16A, when a user maintains a long touch on an icon 251 displayed on the display 151 for more than a predetermined amount of time, the icon 251 gradually grows larger. In addition, FIG. 16B illustrates an icon displayed on the wallpaper moving to a 3D spatial image area other than the display area of the display 151. In particular, in FIG. 16B, when the mobile terminal 100 is tilted while the user touches an icon 261 displayed on the display 151, the controller 180 moves the icon 261 to a space other than the display area.

FIG. 16C illustrates an icon displayed on the wallpaper moving within the display area. In particular, as shown in FIG. 16C, when the user performs a touch-and-drag operation to an icon 271 displayed on the display 151, the controller 180 moves the icon 271 from the display area to a position where the user has performed a drop operation (e.g., released their finger from the icon 271). Thus, as noted above, an icon displayed within a 3D spatial image may be changed in size, and may move to a display area and to a space other than the display area.

Next, FIGS. 17A to 17C include overviews of display screens illustrating a tenth example of displaying a 3D image using binocular disparity in a mobile terminal according to the third embodiment of the present invention. In particular, FIGS. 17A-17C illustrate examples of executing a menu using a constant current constant pressure composite touch screen, or changing an attribute of the menu icon. For example, FIG. 17A illustrates a menu screen 910 including a plurality of menu icons. The menu icon(s) is also displayed as a 3D image by turning on the switching panel unit 155, for example.

Under this circumstance, that is, in a state where the plurality of menu icons are displayed, when the user only touches an ‘LGT’ icon 911, the controller 180 highlights only the LGT icon 911 so the user can see that the ‘LGT’ icon has been selected. At this time, and as shown in FIG. 17B, the controller 180 can also display a window 920 to highlight the selection of the icon. In more detail, the controller 180 can use a 3D image highlighting method using light illumination, changing a perspective feeling of the icon, changing a color of the icon, adding 3D text to the icon, etc.

Under the state where the icon is selected and highlighted, and when the user generates a constant pressure signal by applying a pressure to the pointing device (within a predetermined period of time), the controller 180 executes the ‘LGT’ icon 911 and enters the menu option corresponding to the icon 911 as shown in FIG. 17C. That is, the controller 180 displays a sub-menu 930 of the ‘LGT’ menu/icon 911 on the display 151. Further, although FIG. 17C illustrates the sub-menu 930 as a 2D list format, the description is not limited thereto. That is, a 3D sub-menu icon may be also displayed. Thus, in this example, if a constant current constant pressure composite touch screen is utilized, the 3D icon can be more conveniently selected, and a display set thereto can be easily changed.

The above-described methods can be implemented in a program recorded medium as computer-readable codes. The computer-readable media may include all kinds of recording devices in which data readable by a computer system are stored. The computer-readable media include ROM, RAM, CD-ROM, magnetic tapes, floppy discs, optical data storage devices, and the like for example and also include carrier-wave type implementations (e.g., transmission via Internet).

The present invention encompasses various modifications to each of the examples and embodiments discussed herein. According to the invention, one or more features described above in one embodiment or example can be equally applied to another embodiment or example described above. The features of one or more embodiments or examples described above can be combined into each of the embodiments or examples described above. Any full or partial combination of one or more embodiment or examples of the invention is also part of the invention.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A method of controlling a mobile terminal, the method comprising:
receiving a selection signal from an input unit setting a 3D attribute to at least one item among a plurality of items to be displayed on a display of the mobile terminal; and
turning on a switching panel unit positioned in front of the display, via a controller controlling the switching panel unit, when said at least one item is displayed on the display of the mobile terminal, said switching panel unit displaying left and right eye images of said at least one item such that said at least one item is viewed as a 3D image based on binocular disparity.

2. The method of claim 1, wherein the at least one item displayed as the 3D image includes at least one of a still picture, a moving picture, an icon, a menu option and a text object.

3. The method of claim 1, wherein the selection signal for setting the 3D attribute to the at least one item is linked with a predetermined phonebook item among a plurality of phonebook items.

4. The method of claim 1, further comprising:
receiving a control signal indicating a communication action with respect to said predetermined phonebook item; and
displaying the at least one item linked with the predetermined phonebook item as the 3D image based on the received control signal.

5. The method of claim 4, wherein the communication action includes one of an incoming voice call, an outgoing voice call, an incoming text message, an outgoing text message, an incoming email, an outgoing email, an incoming video call, and an outgoing video call.

6. The method of claim 1, wherein the at least one item set to be displayed as the 3D image is part of a text message to be transmitted to at least one other terminal, and the text message and the 3D attribute is transmitted to the at least one other terminal such that when the text message is received by the at least one other terminal, the at least one item is displayed as the 3D image by the at least one other terminal.

7. The method of claim 1, wherein the at least one item set to be displayed as the 3D image is an item displayed on a wallpaper or screen saver, a broadcast receiving screen, a webpage, a search screen and a map screen.

8. A method of controlling a mobile terminal, the method comprising:
Displaying, on a display of the mobile terminal, only a first portion of a 3D imaginary spatial image pre-stored in a memory of the mobile terminal by turning on a switching panel unit of the mobile terminal;
receiving an inclination signal indicating an inclination of the mobile terminal; and
displaying a second portion of the 3D imaginary spatial image on the display that is different than the first portion in response to the inclination detection signal.

9. The method of claim 8, wherein the 3D imaginary spatial image includes at least one of a menu option, a widget icon, and a file icon.

10. The method of claim 8, further comprising:
receiving a moving signal indicating a movement of at least one item displayed in the 3D imaginary spatial image; and
moving the at least one item from the first portion to the second portion of the 3D imaginary spatial image based on the received moving signal.

11. A mobile terminal, comprising:
an input unit configured to receive a selection signal for setting a 3D attribute to at least one item among a plurality of items to be displayed on a display of the mobile terminal;
a switching unit positioned in front of the display and configured to display left and right eye images of said at least one item; and
a controller configured to turn on the switching panel unit when said at least one item is displayed on the display of the mobile terminal such that said at least one item is viewed as a 3D image based on binocular disparity.

12. The mobile terminal of claim 11, wherein the at least one item displayed as the 3D image includes at least one of a still picture, a moving picture, an icon, a menu option and a text object.

13. The mobile terminal of claim 11, wherein the controller is further configured to link the selection signal for setting the 3D attribute to the at least one item with a predetermined phonebook item among a plurality of phonebook items.

14. The mobile terminal of claim 11, wherein the controller is further configured to receive a control signal indicating a communication action with respect to said predetermined phonebook item and to control the display to display the at least one item linked with the predetermined phonebook item as the 3D image based on the received control signal.

15. The mobile terminal of claim 14, wherein the communication action includes one of an incoming voice call, an outgoing voice call, an incoming text message, an outgoing text message, an incoming email, an outgoing email, an incoming video call, and an outgoing video call.

16. The mobile terminal of claim 11, wherein the at least one item set to be displayed as the 3D image is part of a text message to be transmitted to at least one other terminal, and
wherein the controller is further configured to transmit the text message and the 3D attribute to the at least one other terminal such that when the text message is received by the at least one other terminal, the at least one item is displayed as the 3D image by the at least one other terminal.

17. The mobile terminal of claim 11, wherein the at least one item set to be displayed as the 3D image is an item displayed on a wallpaper or screen saver, a broadcast receiving screen, a webpage, a search screen and a map screen.

18. The mobile terminal of claim 11, wherein the display comprises a constant current static pressure composite touch screen such that the at least one item can be changed by performing a pressure touch action or a touch action on the at least one item.

19. A mobile terminal, comprising:
a display configured to display information;
a memory configured to store a 3D imaginary spatial image;
a switching panel unit positioned in front of the display and configured to display left and right eye images of the 3D imaginary spatial image;
a controller configured to control the display to display only a first portion of a 3D imaginary spatial image stored in the memory by turning on the switching panel unit of the mobile terminal; and
an inclination sensor configured to receive an inclination signal indicating an inclination of the mobile terminal,
wherein the controller is further configured to control the display to display a second portion of the 3D imaginary spatial image that is different than the first portion in response to the inclination detection signal.

20. The mobile terminal of claim 19, wherein the 3D imaginary spatial image includes at least one of a menu option, a widget icon, and a file icon.

21. The mobile terminal of claim 19, wherein the input unit is further configured to receive a moving signal indicating a movement of at least one item displayed in the 3D imaginary spatial image, and
wherein the controller is further configured to move the at least one item from the first portion to the second portion of the 3D imaginary spatial image based on the received moving signal.
